(19) United States
(12) Patent Application Publication
(10) Pub. No.: US 2013/0151191 A1
(43) Pub. Date: Jun. 13, 2013

(54) METHOD TO DETERMINE THE DISTRIBUTION OF TEMPERATURE SENSORS, METHOD TO ESTIMATE THE SPATIAL AND TEMPORAL THERMAL DISTRIBUTION AND APPARATUS

(71) Applicant: ECOLE POLYTECHNIQUE FEDERALE DE LAUS, Lausanne (CH)

(72) Inventors: Juri RANIERI, Lausanne (CH); Alessandro VINCENZI, Renens (CH); Amina CHEBIRA, Lausanne (CH); Martin VETTERLI, Grandvaux (CH); David ATIENZA, Ecublens (CH)

(73) Assignee: ECOLE POLYTECHNIQUE FEDERALE DE LAUSANNE (EPFL), Lausanne (CH)

(21) Appl. No.: 13/632,653

(22) Filed: Oct. 1, 2012

Related U.S. Application Data
(60) Provisional application No. 61/569,799, filed on Dec. 13, 2011.

(51) Int. Cl. G01K 1/00; G06F 15/00

(52) U.S. Cl. 702/130

(57) ABSTRACT

Apparatus comprising M sensors for measuring the temperature on M locations of the apparatus and an estimator configured to estimate a temperature vector of the apparatus with N temperature variables, whereby the estimator is configured to approximate the vector space of the temperature vector by K basis vectors and whereby the M temperature sensors are allocated on the apparatus on the basis of the K basis vectors.

### REFERENCE DATA

This application claims priority of U.S. provisional application 61/569,799, the contents whereof are hereby incorporated.

### FIELD OF THE INVENTION

The present invention concerns a method for determining an optimal distribution of temperature sensors on an apparatus in order to determine the spatial and temporal thermal distribution of the temperature on a chip. The present invention concerns further a method for determining the spatial and temporal thermal distribution of the temperature on an apparatus on the basis of temperature sensors distributed on an apparatus. The present invention concerns also an apparatus with temperature sensors and a work management in dependence of the measured temperature distribution on the apparatus.

### DESCRIPTION OF RELATED ART

The continuous evolution of process technology enables the inclusion of multiple cores, memories and complex interconnection fabrics on a single die. Although many-core architectures potentially provide increased performance, they also suffer from increased IC power densities and thermal issues have become serious concerns in latest designs with deep submicron process technologies. In particular, it is key to design many-core designs that prevent hot spots and large on-chip temperature gradients, as both conditions severely affect system's characteristics, i.e., increasing the overall failure rate of the system, reducing performance due to an increased operating temperature, and significantly increasing leakage power consumption (due to its exponential dependence on temperature) and cooling costs.

Designers organize the floorplan to limit these thermal phenomena, for example, by placing the highest power density components closer to the heat sink. However, the workload execution patterns are fundamental to determine the transient on-chip temperature distribution in multicore designs and, unfortunately, these patterns are not fully known at design time. Furthermore, these issues are amplified in many—core designs, where thermal hot-spots are generated without a clear spatio-temporal pattern due to the dynamic task set execution nature, based on external service requests, as well as the dynamic assignment to cores by the many-core operating systems (OS).

Therefore, latest many-core designs include dynamic thermal management approaches that incorporate thermal information into the workload allocation strategy to obtain the best performance while avoiding peaks or large gradients of temperature.

The temperature map of a processor can be estimated by the solution of the direct problem, given the heat sources and the physical model of the temperature diffusion (e.g. a nonlinear diffusion equation). This approach is limited by its requirements: the knowledge of the heat sources can be ascribed to the knowledge of the detailed power consumption of the different components. This information is not usually known at runtime. Even if we can estimate this power distribution, the computation of a solution would require an excessive computational power.

Alternatively, the temperature distribution, mostly an instantaneous temperature map, of a processor can be estimated by the solution of the inverse problem, given the value of the temperature in some locations and some a-priori information about the temperature map. It is impossible to solve the inverse problem from few, spatially localized, imprecise measurements without some a-priori constraints on the temperature map, such as e.g. limited bandwidth. The performance is significantly impacted by the small number of available sensors and the structure we consider for the thermal map, i.e. the a-priori information. Nowadays, a few sensors are already deployed on chips to obtain this thermal information. However, their number is limited by area/power constraints and the optimal placement of sensors to detect all the worst-case temperature scenarios is a very complex problem that has received significant attention in recent years.

Unfortunately, the reconstruction of the entire thermal map from a limited number of thermal sensors poses many—and still unresolved—questions. In particular, for each specific many-core architecture, the two fundamental questions to answer are the possible trade-offs regarding the number of sensors to place and the reachable degree of temporal and spatial thermal precision, as well as the sensor locations to maximize the thermal map reconstruction performance.

In “Thermal monitoring of real processors: techniques for sensor allocation and full characterization” published by Nowroz, A. N., Cochran, R., And Reda, S. in DAC (2010), the optimal location of k sensors for measuring the temperatures on the many-core architecture are determined on the basis of a K-means algorithm representing the K centers of energy on the chip. The thermal map is estimated on the basis of the measurements of the sensors on the chip and using the fact that the frequency representation of the temperature map is a sparse matrix, since only low frequencies are different from zero. However, the errors of the estimated temperature map compared to the real temperature map are large and the thermal hot spots and high gradients of the temperature map cannot be determined with sufficient exactness. In addition, it is not that easy to consider the constraints of the allocation of the sensor on the chip with this allocation determining algorithm.

### BRIEF SUMMARY OF THE INVENTION

Therefore, it is an object of the invention to find a method and apparatus for estimating the temperature distribution of a chip or apparatus.

It is another object of the invention to find a method for allocating the temperature sensors on the chip or apparatus and a chip/apparatus with such an optimal sensor allocation.

According to the invention, these aims are achieved by a method according to claim 1 for determining the allocation of M temperature sensors on an apparatus for estimating the temperature distribution on the apparatus comprising the following step. An N-dimensional temperature vector with N temperature variables describing temperatures at N locations on the apparatus is provided. The vector space of the temperature vector is approximated by K basis vectors, whereby the allocation of the M temperature sensors is based on the K basis vectors.

According to the invention, these aims are achieved by an apparatus according to claim 10 comprising the following features. M sensors for measuring the temperature on M locations of the apparatus. An estimator configured to estimate a temperature vector of the apparatus with N temperature variables, whereby the estimator is configured to approximate the vector space of the temperature vector by K basis vectors, whereby the M temperature sensors are allocated on the apparatus on the basis of the K basis vectors.

According to the invention, these aims are achieved by a method according to claim 18 for estimating a thermal distribution of an apparatus comprising the following steps. Providing an N-dimensional temperature vector with N temperature variables describing temperatures at N locations on the apparatus. The vector space of the temperature vector is approximated by K basis vectors of a vector transformation of the standard basis. The temperature at M locations on the processor is measured. The K coefficients corresponding to the K basis vectors are estimated on the basis of the M measurements of the temperature. The temperature vector is estimated on the basis of the K estimated coefficients, whereby the basis vectors are predetermined on the basis of a plurality of realizations of the temperature vector.

The invention suggests to choose a basis system which represents the temperature map with a low number K of basis vectors. This already yields very good results for estimating the temperature map. In order to further optimize the estimation result, the points of measurement of the temperature on the apparatus is predetermined on the basis of the chosen K basis vectors. Therefore, the allocation of the measurement points on the apparatus is adapted to the method of estimating the temperature vector and the estimation result is dramatically improved.

The dependent claims refer to further advantageous embodiments of the invention.

In one embodiment, the allocation of the M temperature sensors is based on the K basis vectors which are the same as used in the apparatus to estimate the temperature distribution on the apparatus.

In one embodiment, a K×N dimensional first transformation matrix is provided whose columns are proportional to the K basis vectors, and the M locations of the M temperature sensors are selected on the basis of the condition number of a second transformation matrix resulting from removing M-N rows from the first transformation matrix, wherein the locations corresponding to the M remaining rows of the first transformation matrix correspond to the M locations of the M temperature sensors.

In one embodiment, the allocation of the M temperature sensors is based on the correlation between the K basis vectors.

In one embodiment, a correlation matrix of the K basis vectors are determined and the M-N rows with the highest non-diagonal elements are removed and the M temperature sensors are located on the apparatus on the M locations corresponding to the M remaining rows of the correlation matrix.

In one embodiment, the number M is chosen such that the correlation matrix resulting from removing the N-M rows with the highest non-diagonal element from the first transformation matrix has rank K and a minimal number of rows.

In one embodiment, the K basis vectors are determined on the basis of a plurality of realizations of the temperature vector.

In one embodiment, the K basis vectors are eigenvectors of the covariance matrix of the temperature vector.

In one embodiment, K is smaller than N and K is equal to or smaller than M.

In one embodiment, the temperature vector \hat{x} is estimated by \hat{x}=Φ_{K}(\tilde{Φ}*_{K}\tilde{Φ}_{K})⁻¹\tilde{Φ}*_{K}x_{S}, wherein Φ_{K} is the K×N Matrix comprising the K basis vectors as columns, \tilde{Φ}_{K} is the K×M Matrix comprising the K basis vectors as columns with only the M rows corresponding to the M locations on the apparatus of the measured temperature and x_{S} is the M dimensional vector of measured temperatures.

In one embodiment, the apparatus is a chip, preferably a processor.

### BRIEF DESCRIPTION OF THE DRAWINGS

The invention will be better understood with the aid of the description of an embodiment given by way of example and illustrated by the figures, in which:

FIG. 1 shows a simplified floorplan of an exemplary chip;

FIG. 2 shows indices of a temperature map for the exemplary chip;

FIG. 3 shows the steps performed offline of one embodiment of the method for estimating the temperature vector according to the invention;

FIG. 4 shows the steps performed online of one embodiment of the method for estimating the temperature vector according to the invention;

FIG. 5 shows an embodiment of the chip according to the invention;

FIG. 6 shows one embodiment of the method for determining the allocation of the temperature sensors according to the invention; and

FIG. 7 shows one embodiment of the method for determining the location of the temperature sensors from the K basis vectors according to the invention.

### DETAILED DESCRIPTION OF POSSIBLE EMBODIMENTS OF THE INVENTION

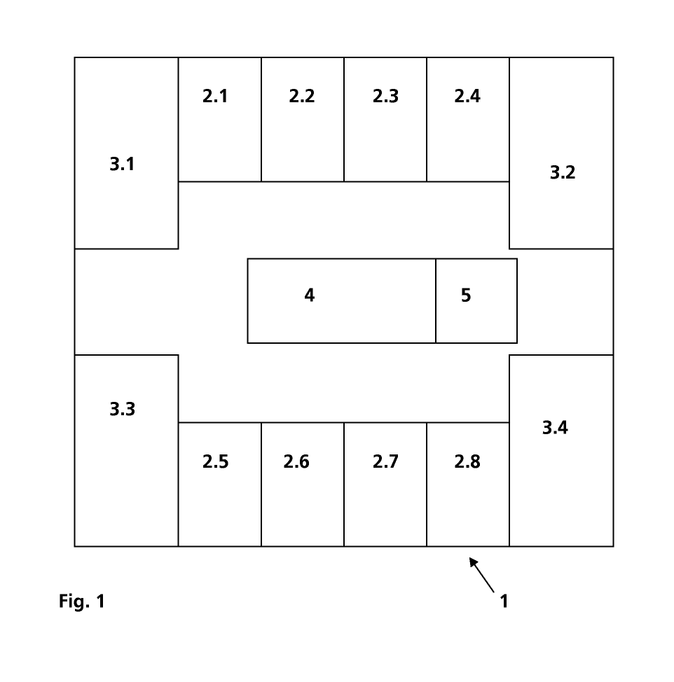

FIG. 1 shows a floorplan of a chip 1 according to one embodiment. In this embodiment the chip 1 is an 8-core processor comprising eight cores 2.1 to 2.8, four Level 2 caches 3.1 to 3.4, a crossbar 4 and a floating point unit (FPU) 5. It is obvious that chip 1 is much more complex than shown and comprises more parts than mentioned. It is also clear that the invention is not limited to multi-core processors or processors in general, but works with any kind of chip. The chip 1 shown in FIG. 1 has different temperature distributions depending on several parameters like the actual workload, the ambience temperature, the power of the cooling, etc.

Before describing the methods and apparatuses according the embodiments of the invention, the model for estimating the temperature distribution of the chip 1 is presented.

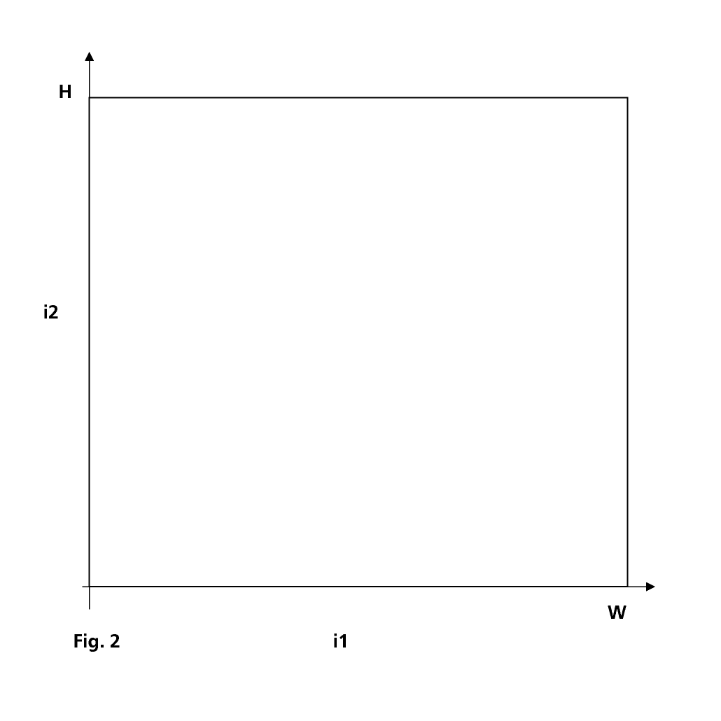

In order to describe the temperature distribution of the chip 1, a discretized temperature map t is defined as shown in FIG. 2. The temperature at coordinates it and i2 is defined as t[i1, i2] for 0≦i1≦H−1 and 0≦i2≦W−1. Where W and H are the width and the height of the discretized temperature map, respectively. The temperature map is vectorized as x[i], for 0≦i≦N−1 and N=WH, that is

$$x [ i ] = t [ i mod H , ⌊ \frac{i}{W} ⌋ ] . \qquad ( 1 )$$

In other words, the columns of the discrete thermal map are stacked to transform the matrix t into a vector x. Preferably, the natural numbers H and W are chosen such that the geometry of the surface of the chip 1 is covered by equidistant coordinates and that the existence of temperature variations between two neighbouring coordinates is excluded. However, it is understood that any coordinate system can be chosen. For example the regions prone to higher thermic stress, e.g. regions with higher temperature and/or regions with more complex and irregular temperature spreading patterns and/or regions with higher temperature gradients, could include a more dense net of coordinates than the remaining regions on the chip.

Then, the N-dimensional temperature vector is approximated by a projection onto the low-dimensional linear subspace that minimizes the mean square error. This allows to describe the N-dimensional thermal map t or the equivalent temperature vector x with only K, coefficients, where K is much smaller than N. Any vector x can be represented using a basis Φ as,

$$x [ i ] = {\sum }_{n = 0}^{N - 1} Φ [ i , n ] α [ n ] , \qquad ( 2 )$$

where α[n] are the coefficients of the expansion over the vector basis Φ with the N-dimensional basis vectors Φ[i]. Note that, once we define a vector basis for the data, knowing the coefficients α is equivalent to knowing the temperature map x.

It is looked for the optimal approximation subspace using a basis. Considering that we want to keep only K coefficients α out of N, we suggest that the optimal subspace is the K-dimensional one introducing the smallest error. The approximated temperature vector \hat{x} is given by the following over-determined system of equations,

$$\begin{matrix}\hat{\vec{x}} = [ \begin{matrix}\hat{x} [ 0 ] \\ ⋮ \\ \hat{x} [ N ]\end{matrix} ] \\ = [ \begin{matrix}Φ [ 0 , 0 ] & … & Φ [ 0 , K - 1 ] \\ ⋮ & ⋱ & ⋮ \\ Φ [ N - 1 , 0 ] & … & Φ [ N - 1 , K - 1 ]\end{matrix} ] [ \begin{matrix}α [ 0 ] \\ ⋮ \\ α [ K - 1 ]\end{matrix} ] \\ = {Φ}_{K} {α}_{K} ,\end{matrix} \qquad ( 3 )$$

where the subscript K indicates the selection of the first K columns for a matrix or the first K elements for a vector. This approximation is equivalent to a projection onto the K-dimensional subspace spanned by the columns of Φ_{K}. The following optimization problem is defined to find this basis. Note that, the first K columns of Φ will define the optimal subspace we are looking for. Problem 1: Find the set of basis vectors Φ such that the approximation \hat{x} with the first K<N components,

$$\hat{x} [ i ] = {\sum }_{n = 1}^{K - 1} Φ [ i , n ] α [ n ] , \qquad ( 4 )$$

minimizes the following error,

$$e = E [ {\vert x - \hat{x} \vert}^{2} ] = E [ {\vert {\sum }_{n = K}^{N - 1} Φ [ i , n ] α [ n ] \vert}^{2} ] . \qquad ( 5 )$$

This dimensionality reduction technique is well known in other fields under different names, such as Principal Component Analysis (PCA) and Karhunen-Loeve Transform (KTL). It has an analytic solution and it requires the covariance matrix Cₓ, that is defined for real zero-mean random variables as

Cₓ[i,j]=E[x[i],x[j]]. (6)

In order to estimate this matrix, a plurality of temperature vectors x for several work load scenarios is determined. Such temperature vectors x can be retrieved either by measuring the temperature maps during use or by simulating the temperature maps on the basis of the electrical inputs in the components of the chip. The latter has the advantage that the basis can already be determined, when the chip is still in the design stage. Using the set of temperature vectors simulated or measured, the covariance matrix Cₓ can be estimated. The quality of the available dataset impacts the quality of the estimate Cₓ. This estimation is a well-studied topic and will not be discussed here. The solution to Problem 1 is given in the following proposition for optimal approximation: Consider a set of temperature vectors {x} with zero mean and covariance matrix Cₓ. The orthonormal basis Φ_{K} that defines the approximation \hat{x} with the minimum error e, is formed by the first K eigenvectors of Cₓ ordered in decreasing values of its eigenvalues λₙ. Moreover, the approximation error is monotonically decreasing when increasing K as

$$e = {\sum }_{n = K}^{N - 1} {λ}_{n} . \qquad ( 7 )$$

The connection between Cₓ and the optimal basis has an intuitive explanation. In fact, if the temperatures at different spatial points are statistically correlated, then Cₓ has some elements outside its diagonal different from zero. These elements can be used to infer the temperature at points without sensors. Moreover, if the correlation is strong, then the eigenvalues λₙ of Cₓ decay fast and the temperature x can then precisely be approximated with a lower K, see (7). Recall that K is the number of parameters we have to estimate from the sensor measurements; having the approximation with the minimum K while keeping a good precision is fundamental to have a truthful reconstruction with just few sensors. Since the Eigenvectors can even be represented as maps by inverting (1), the eigenvectors of Cₓ are also called Eigenmaps.

The temperature vector x is now defined by only its K coefficients α_{K} in the basis Φ_{K}. In the following, it will be explained how to estimate the coefficients α_{K} from the sensors measurements. In principle, the coefficients α_{K} can be found by inverting the over-determined linear system of equations given in (3). However, this would require the knowledge of the temperature x[i] at every spatial location i. Assuming that only M sensors at are placed at locations S={j₁, j₂, . . . , j_{M}}. Considering (3), it is equivalent to remove all the rows of Φ_{K} beside those indexed by S:

$$\begin{matrix}{x}_{S} = [ \begin{matrix}x [ {j}_{1} ] \\ ⋮ \\ x [ {j}_{M} ]\end{matrix} ] \\ = [ \begin{matrix}Φ [ {j}_{1} , 0 ] & … & Φ [ {j}_{1} , K - 1 ] \\ ⋮ & ⋱ & ⋮ \\ Φ [ {j}_{M} , 0 ] & … & Φ [ {j}_{M} , K - 1 ]\end{matrix} ] [ \begin{matrix}α [ 0 ] \\ ⋮ \\ α [ K - 1 ]\end{matrix} ] \\ = {\tilde{Φ}}_{K} {α}_{K} ,\end{matrix} \qquad ( 8 )$$

where \tilde{Φ}_{K} is a matrix formed by the rows of Φ_{K} corresponding to the sensor locations S, x_{S} is a vector containing the sensor measurements and α_{K} is the unknown vector. Before the solution of (8) is characterized, noise needs to be introduced into the picture. More precisely, there are two different noise sources affecting the measurements. First, there is the approximation error e=x−\hat{x} that is systematic and it is due to the approximation on the K dimensional subspace. Second, the measurements are corrupted by a significant amount of noise due to many factors, such as thermal noise, quantization and calibration inaccuracies. Therefore, the following modification of (8),

x_{S}+w=\tilde{Φ}_{K}α_{K}, (9)

is considered, where w is the M-dimensional noise vector. There is no exact solution to (9). However, the coefficients \hat{α}_{K}can be found such that the error with respect to the measured temperature x_{S} is minimized. Namely, the following least square problem,

$${min}_{{\hat{α}}_{K}} {‖ {x}_{s} - {\tilde{Φ}}_{K} {\hat{α}}_{K} ‖}_{2}^{2} \qquad ( 10 )$$

is solved. If S, i.e. the location of the M sensors, is chosen such that M≧K and rank(\tilde{Φ}_{K})=K, then the reconstruction of the temperature vector \tilde{x} is unique. In addition, the reconstruction error is bounded by the condition number κ(\tilde{Φ}_{K}) of \tilde{Φ}_{K} and the noise energy

$${e}_{r} = \frac{‖ \tilde{x} - x ‖}{‖ x ‖} = O ( κ ( {\tilde{Φ}}_{K} ) ) {‖ w ‖}^{2} . \qquad ( 11 )$$

Consequently, given M sensors and an optimal K-dimensional subspace Φ_{K}, the optimal sensor location is the one that minimizes the condition number of \tilde{Φ}_{K}. If this condition number is minimal, the reconstruction error is minimal for the given amount of noise w. Note that increasing K will in general increase κ(\tilde{Φ}_{K}) and consequently will increase the reconstruction error eᵣ. Therefore, an optimal K is such that the sum of e and eᵣ is minimal. Thus, the condition number is the perfect metric to evaluate different sensing patterns and find the optimal one. The solution of problem (10) is

\tilde{x}Φ_{K}(\tilde{Φ}*_{K}\tilde{Φ}_{K})⁻¹\tilde{Φ}*_{K}x_{S}. (12)

This gives a linear estimator for the temperature vector and thus for the temperature map of the chip on the basis of the M temperature measurements.

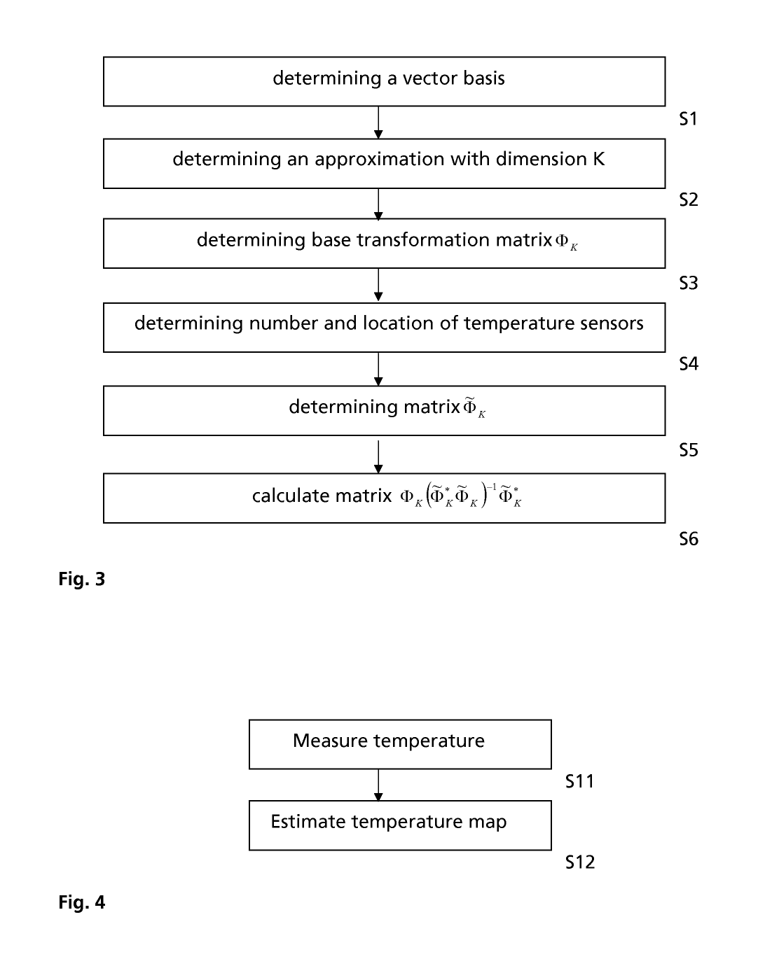

FIGS. 3 and 4 show an embodiment of the method for estimating the thermal distribution of a chip like the multi-core processor 1. While FIG. 3 shows the steps being performed offline before estimating the temperature distribution of the chip online, FIG. 4 shows the steps being performed online, when estimating the thermal distribution online. The steps performed in FIG. 4 use the results obtained by the method steps in FIG. 3, preferably the matrix calculated in step S6 as described below.

In step S1, a set of temperature maps and consequently also a set of temperature vectors, which correspond to the temperature maps by equation (1), is determined. The set of temperature maps are determined in one embodiment by simulating the temperature distribution of the chip on the basis of the known parts of the chip and their electrical inputs. Consequently, the development of the temperature map of the chip over time for constant and varying electrical inputs could be retained already at design time. In another embodiment, the set of temperature maps is by measuring the temperature distribution of the hardware-chip e.g. by a sensitive infrared camera or other measuring sensors for measuring high-resolution and highly sensible temperature distributions. In both embodiments, the set of temperature maps should be temperature maps at discrete time points for a large number of work scenarios of the chip such that the set of temperature maps is a good statistical representation of the statistical temperature vector x.

In step S2, a vector basis is determined which represents the N-dimensional vector space of the N-dimensional temperature vector x and is different from the standard basis. A good vector basis for the statistical temperature vector x is found on the basis of the set of temperature vectors determined in step S1. In one embodiment, the vector basis for the statistical temperature vector x is determined on the basis of the covariance matrix Cₓ of the statistical temperature vector x. This covariance matrix Cₓ is estimated on the basis of the set of temperature vectors determined in step S1. In one preferred embodiment, the vector basis is chosen as the N eigenvectors of the covariance matrix Cₓ. However, the invention is not restricted to the use of the eigenvectors. Any other vector basis such as a discrete Fourier transform, discrete cosinus transform, etc. can be used.

In step S3, the vector space of the statistical temperature vector x is approximated by only K<N basis vectors of the basis vectors chosen in step S2. The K eigenvectors with the largest eigenvalues are the optimal solution to approximate the vector space of the statistical temperature vector x with K<N coefficients and providing the lowest approximation error e. However, the invention is not restricted this selection of eigenvectors, any other selection of eigenvectors or any other selection of K basis vectors of another vector basis is also within the scope of the invention. The selection of the dimension of the approximation-dimension K will be described later.

In step S4, the K×N dimensional transformation matrix Φ_{K} defined in equation (3) is determined on the basis of the K N-dimensional basis vectors defined in step S3. In step S5, the number M and location of the temperature sensors on the chip are determined. Preferably, the allocation of the temperature sensors is determined according to the method for determining the allocation of temperature sensors as described further below. However, the method for estimating the temperature distribution is not restricted to such allocations of the temperature sensors. The method for estimating the temperature distribution is also applicable to chips with predetermined temperature sensor allocations or other methods for determining the allocation of the temperature sensors. In step S6, the K×M dimensional matrix \tilde{Φ}_{K} is provided as determined in equation (8) by the locations S of the M temperature sensors. In step S6, the estimation matrix

M=Φ_{K}(\tilde{Φ}*_{K}\tilde{Φ}_{K})⁻¹\tilde{Φ}*_{K} (13)

is calculated and stored for the online estimation method described in the following.

FIG. 4 shows the steps performed online for estimating the temperature distribution. In step S11, the temperature at one time instance is measured by the M temperature sensors on the chip at the locations S. The vector of measured temperatures at the one time instance is multiplied in step S12 with the matrix M

\tilde{x}=Mx_{S} (14)

such that the estimator \tilde{x} for the temperature vector x at the one time instance is calculated. The temperature vector estimator \tilde{x} can be transformed in a temperature map estimator \tilde{t}. The temperature map estimator can then be used for example for controlling the temperature of a chip. The steps S11 and S12 are periodically repeated in order to estimate the evolution of the temperature map estimator over the time. This evolution can be used to control the power allocation of the single components of the chip in order to prevent hot spots and high temperature gradients on the chip. This is done most simply by reducing the usage of a component whose peak temperature is over a certain temperature threshold or whose temperature gradient is over a certain threshold. In the example of a multi-core chip, the temperature information like the temperature vector estimator or the temperature map estimator would be plugged in the workload manager that allocates different jobs to different cores. Knowing the evolution of the temperature up to the last instant, it could directly avoid thermal stress scenarios by opportunely allocate the future jobs on the basis of the temperature information.

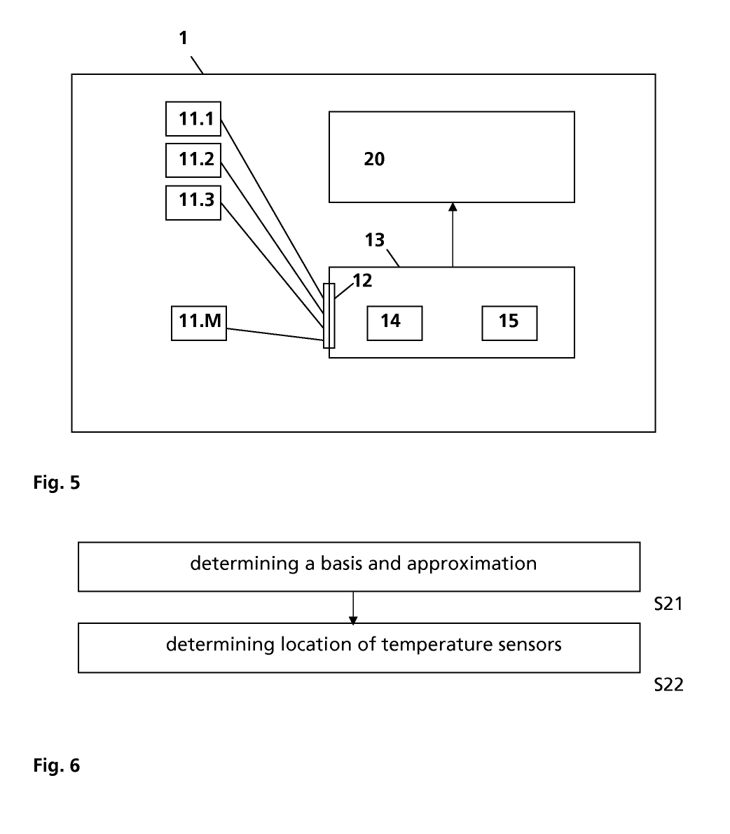

FIG. 5 shows a schematic view of the chip 1. The chip 1 comprises a temperature estimation apparatus 10 as one embodiment of the apparatus for estimating a thermal distribution on the chip 1 and a thermal controller 20 for controlling the components of the chip 1 like the one presented in FIG. 1 on the basis of a temperature map received from a not shown temperature estimation apparatus. The temperature estimation apparatus comprises M temperature sensors 11.1, 11.2, . . . , 11.M, an interface 12, an estimator 13. The M temperature sensors 11.1, 11.2, . . . , 11.M are positioned at the locations S on the chip 1 for measuring the temperature at the positions S. Each of the M temperature sensors 11.1, 11.2, . . . , 11.M is connected to the estimator 13 via the interface 12. Therefore, the estimator 13 receives via the interface 12 the measured temperatures at the M locations S. The estimator 13 comprises a storage means 14 for storing the matrix M predetermined in step S6. The estimator 13 comprises further a calculator means 15 for multiplying the vector of measurements received via the interface 12 with the Matrix M stored in the storage means 14. The result \tilde{x}=Mx_{S} is given to the thermal control 20. In this embodiment the temperature estimation apparatus 10 is arranged directly on the chip. However, the temperature estimation apparatus 10 can also be arranged outside of the chip 1 and comprise only the interface 12 which is connected to the M temperature sensors 11.1, 11.2, . . . , 11.M on the chip and does not comprise the M temperature sensors 11.1, 11.2, . . . , 11.M themselves.

In the following, an embodiment of the method for determining the allocation of temperature sensors will be described. FIG. 6 shows such an embodiment. In step S21, a vector basis and an approximation thereof is chosen. In one embodiment, the K basis vectors are chosen the same as the ones used for the estimation in steps S1 to S12. Those basis vectors are preferably the eigenvectors determined in S2, but can also be different basis vectors, if the estimation method uses another vector basis and/or another approximation of the vector basis. In step S22, the location of the M temperature sensors is determined on the basis of the chosen K basis vectors of step 1.

Since the reconstruction error eᵣ of the estimator (12) depends on the condition number κ(\tilde{Φ}_{K}) of \tilde{Φ}_{K}, for a given number of M temperature sensors the optimal allocation the optimal sensor location is the one that minimizes the condition number κ(\tilde{Φ}_{K}) of \tilde{Φ}_{K}. Therefore, in one embodiment, the allocation of the temperature sensors on the chip is based on the condition number of matrix \tilde{Φ}_{K}. For example, the condition number could be calculated for all M out of N combinations of allocating the M temperature sensors and the allocation with the lowest condition number could be chosen. Since the temperature map has normally a very high resolution (e.g. N=64000), the calculation of the condition number of all M out of N combinations includes very long computation times.

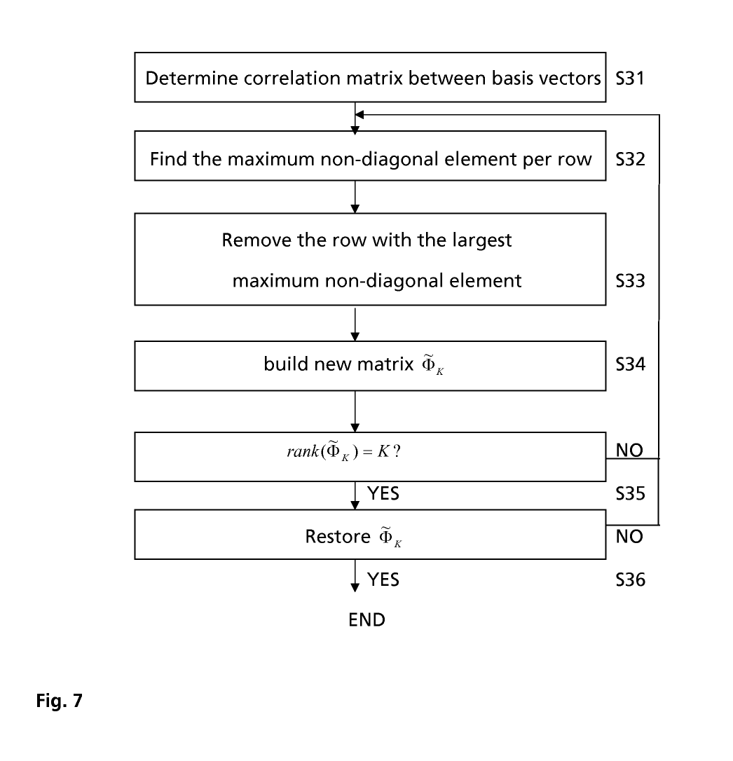

FIG. 7 shows another embodiment. In step S31 the correlation matrix between all K basis vectors is calculated. This can be done e.g. by normalizing the rows of Φ_{K} so that the matrix U of the normalized rows of Φ_{K} is achieved. The correlation matrix G is then achieved by multiplying the matrix U with its complex transpose U* to G=UU*. Then in step S32, the maximum non-diagonal element of G is determined, which can be computed by subtracting the unity matrix from G and finding the maximum element of this matrix. In step S33, the row with the maximum non-diagonal element of G is removed and in step S34 a new matrix \tilde{Φ}_{K} is yield by removing the same row in \tilde{Φ}_{K} of the previous step. When removing the row, the index of this row and the other rows are maintained in order to know the original index of the last M remaining rows. The original index of the M remaining rows give the information about the positions of the M temperature sensors. In step S35, it is tested if the rank of \tilde{Φ}_{K} is smaller than K. If not, the steps S32 to S35 are repeated and the rows with the respective highest off-diagonal element of the correlation matrix G are removed until the rank of \tilde{Φ}_{K} is smaller than K. If the rank of \tilde{Φ}_{K} is smaller than K, in step S36 the last \tilde{Φ}_{K} from the previous iteration is restored. Consequently, \tilde{Φ}_{K} has rank K and minimum number of rows. The indices of the remaining rows correspond to the M locations for the M temperature sensors.

Even if the invention is described in the context of a chip, the invention is not restricted to a chip, but is applicable to any kind of apparatus. Such an apparatus might be any chip, any integrated circuit, any computer, any server, any data center comprising a large number of computer, server, network devices and/or storage systems. The apparatus is prefereably anything which creates heat by its electrical work. However, this invention is also applicable to mechanical or other apparatuses which create heat by their function. The apparatus might also be a house or a room comprising further heat creating devices such as server rooms.

1. Method for determining the allocation of M temperature sensors on an apparatus for estimating the temperature distribution of the apparatus comprising the steps of:
providing an N-dimensional temperature vector with N temperature variables describing temperatures at N locations on the apparatus;
approximating the vector space of the temperature vector by K basis vectors,
whereby the allocation of the M temperature sensors is based on the K basis vectors.

2. Method according to claim 1, wherein the allocation of the M temperature sensors is based on the K basis vectors which are the same as used in the apparatus to estimate the temperature distribution on the apparatus.

3. Method according to claim 1, wherein a K×N dimensional first transformation matrix is provided whose columns are proportional to the K basis vectors, and the M locations of the M temperature sensors are selected on the basis of the condition number of a second transformation matrix resulting from removing M-N rows from the first transformation matrix, wherein the locations corresponding to the M remaining rows of the first transformation matrix correspond to the M locations of the M temperature sensors.

4. Method according to claim 1, wherein the allocation of the M temperature sensors is based on the correlation between the K basis vectors.

5. Method according to claim 4, wherein a correlation matrix of the K basis vectors are determined and the M-N rows with the highest non-diagonal elements are removed and the M temperature sensors are located on the apparatus on the M locations corresponding to the M remaining rows of the correlation matrix.

6. Method according to claim 5, wherein the number M is chosen such that the correlation matrix resulting from removing the N-M rows with the highest non-diagonal element from the first transformation matrix has rank K and a minimal number of rows.

7. Method according to claim 1, wherein the K basis vectors are determined on the basis of a plurality of realizations of the temperature vector.

8. Method according to claim 7, wherein the K basis vectors are eigenvectors of the covariance matrix of the temperature vector.

9. Method according to claim 1, wherein K is smaller than N and K is equal to or smaller than M.

10. Apparatus comprising
M sensors for measuring the temperature on M locations of the apparatus,
an estimator configured to estimate a temperature vector of the apparatus with N temperature variables, whereby the estimator is configured to approximate the vector space of the temperature vector by K basis vectors;
whereby the M temperature sensors are allocated on the apparatus on the basis of the K basis vectors.

11. Apparatus according to claim 10, wherein a K×N dimensional first transformation matrix is provided whose columns are proportional to the K basis vectors, and the M locations of the M temperature sensors are selected on the basis of the condition number of a second transformation matrix resulting from removing M-N rows from the first transformation matrix, wherein the locations corresponding to the M remaining rows of the first transformation matrix correspond to the M locations of the M temperature sensors.

12. Apparatus according to claim 10, wherein the allocation of the M temperature sensors is based on the correlation between the K basis vectors.

13. Apparatus according to claim 12, wherein a correlation matrix of the K basis vectors are determined and the M-N rows with the highest non-diagonal elements are removed and the M temperature sensors are located on the apparatus on the M locations corresponding to the M remaining rows of the correlation matrix.

14. Apparatus according to claim 13, wherein the number M is chosen such that the correlation matrix resulting from removing the N-M rows with the highest non-diagonal element from the first transformation matrix has rank K and a minimal number of rows.

15. Apparatus according to claim 10, wherein the K basis vectors are determined on the basis of a plurality of realizations of the temperature vector.

16. Apparatus according to claim 15, wherein at least one of the K basis vectors is an eigenvector of the covariance matrix of the temperature vector.

17. Apparatus according to claim 10 further comprising a controller for controlling parts of the apparatus on the basis of the temperature vector.

18. Method for estimating a thermal distribution of an apparatus comprising the steps of:
providing an N-dimensional temperature vector with N temperature variables describing temperatures at N locations on the apparatus;
the vector space of the temperature vector is approximated by K basis vectors of a vector transformation of the standard basis;
measuring the temperature at M locations on the processor;
estimating the K coefficients corresponding to the K basis vectors on the basis of the M measurements of the temperature; and
estimating the temperature vector on the basis of the K estimated coefficients,
whereby the basis vectors are predetermined on the basis of a plurality of realizations of the temperature vector.

19. Method according claim 18, wherein at least one basis vector is an eigenvector of the covariance matrix of the plurality of realizations of the temperature vector.

20. Method according to claim 19, wherein the K basis vectors are the eigenvectors of the covariance matrix of the plurality of realizations of the temperature vector corresponding to the largest eigenvalues.

21. Method according to claim 18, wherein the plurality of realizations of the temperature vector is determined on the basis of simulations of working scenarios of the apparatus.

22. Method according to claim 18, wherein K is smaller than N and K is smaller than or equal to M.

23. Method according to claim 18, wherein the temperature vector \hat{x} is estimated by \hat{x}=Φ_{K}(\tilde{Φ}*_{K}\tilde{Φ}_{K})⁻¹\tilde{Φ}*_{K}x_{S}, wherein Φ_{K} is the K×N Matrix comprising the K basis vectors as columns, \tilde{Φ}_{K} is the K×M Matrix comprising the K basis vectors as columns with only the M rows corresponding to the M locations on the apparatus of the measured temperature and x_{S} is the M dimensional vector of measured temperatures.

24. Method according to claim 18, wherein the M locations for measuring the temperature on the apparatus are selected on the basis of the correlation between K basis vectors.

25. Method according to claim 18, wherein the M locations on the apparatus are selected on the basis of the K basis vectors.
